(19) United States
(12) Patent Application Publication
(10) Pub. No.: US 2017/0130175 A1
(43) Pub. Date: May 11, 2017

(54) HEAVY-DUTY LAUNDRY DETERGENT WIPE WITH CONTROLLED PHASE EMISSION DIFFUSION OF THE WASHING ACTIVE SUBSTANCES

(71) Applicant: COIN CONSULTING UG (HAFTUNGSBESCHRÄNKT), Menden (DE)

(72) Inventors: Marcus Mausberg, Menden (DE); Michael Pulina, Krefeld (DE)

(73) Assignee: COIN CONSULTING UG (HAFTUNGSBESCHRÄNKT), Menden (DE)

(21) Appl. No.: 15/319,258

(22) PCT Filed: Jun. 11, 2015
(86) PCT No.: PCT/DE2015/000279

§ 371 Date: Dec. 15, 2016

(30) Foreign Application Priority Data
Jun. 17, 2014 (DE) 10 2014 008 586.6

(51) Int. Cl. C11D 17/04; C11D 11/00

(52) U.S. Cl. CPC C11D 17/041; C11D 11/0017

(57) ABSTRACT

The present invention discloses a method for manufacturing a heavy-duty laundry detergent wipe, characterized by the following steps: (a) hydrophobic coating of a hydrophilic substrate or hydrophilic coating of a hydrophobic substrate for obtaining a multilayered carrier substrate which is solid at ambient temperature, (b) applying a dispersion consisting of a liquid washing detergent and a water insoluble functional additive to the substrate. The present invention further discloses a heavy-duty laundry detergent wipe, comprising a substrate which is solid at ambient temperature and a dispersion applied to the substrate and consisting of a liquid washing detergent and a water insoluble functional additive, characterized in that the carrier substrate consists of a hydrophilic substrate provided with a hydrophobic coating or of a hydrophobic substrate provided with a hydrophilic coating.

### FIELD OF THE INVENTION

The present invention is directed to heavy-duty laundry detergent wipes for cleaning textiles and, in particular, to heavy-duty laundry detergent wipes, wherein the phase emission diffusion is controlled, and a method for producing same.

### BACKGROUND OF THE INVENTION AND PRIOR ART

The pursuit of hygiene exists from the beginning of mankind. Hygiene eventually is an important aspect of everyday life. The hygienic approach primarily consists in maintaining the health. In addition to the general cleaning effects scent and improved cleaning power of the raw material compositions have also come under scrutiny due to extended possibilities. Cleaning power optimization is particularly characterized by the ability to extend a hygienically clean state and an improvement of the degree of cleaning.

Nowadays hygiene can be divided into the fields of body, surface and textile hygiene. The latter is divided into applications depending on textile material and color. At least since the Nineties of the 20^{th} century the consumer's awareness has been raised of ecological cleaning. In this regard, it is desirable to maintain the advantages of conventional washing detergents, on the one hand, and to find further innovative and ecologically feasible product solutions, on the other hand.

With the beginning of industrial production, laundry detergents have been realized as powders. This very day, a powder laundry detergent consists of a mixture of different washing active substances.

With the progress during the development of laundry detergents enzymes and other new surfactant compositions entered this market segment. In addition to the substances necessary for cleaning large amounts of filler material are added nowadays. Accordingly, no change of the consumer's dosing behavior was necessary. First attempts to omit filler material resulted in an overdosing of the surfactants due to the application the users were used to.

Then liquid washing detergents were introduced which could be dosed residue-free and, thus, offered a physical alternative to the mixture of solids of laundry detergents. However, up to now liquid washing detergents do not accomplish the cleaning level of a heavy-duty laundry detergent (i.e., a mixture of solids). This is due to the fact that a liquid washing detergent is limited to liquid components or components which are well soluble in water. The essential substances missing in a liquid washing detergent are the zeolites. The latter support dirt adsorption and brightening/color fastness during the application.

Another important factor for optimal cleaning using a commercially available washing machine is the timely dosing of the washing active substances during the washing process. This is realized via the washing program when available detergents (powder detergents and liquid detergents) are used. The dosing chambers permit a differentiation over time, as far as adding softeners and detergents of the pre and main washing cycles is concerned.

A current product trend is the way of portioning the washing detergent. This can be achieved, on the one hand, by packing a liquid washing detergent in small polymer pouches. In this case, all washing active substances are released at the time when the polymer pouch is dissolved.

Another physical modification of the washing detergent consists in mixing a washing detergent with a fatty alcohol in order to achieve desired forms. In this case, the washing active substances are released via the dissolution of the structure of the detergent/fat alcohol mixture.

As disclosed in DE 10 2010 060 126 A1, a multi-phase product can be provided. The laundry detergent wipe disclosed therein is characterized by combining a carrier material with an impregnating liquid (two-phase product). The preferred use of hydrophilic carrier materials and solutions leads to an outwashing process which is comparable to the dissolution of the polymer pouches mentioned above in connection with liquid detergents packed in small polymer pouches. Only the activation at an earlier point in time could be observed.

DE 10 2013 014 015 discloses a further optimized product, wherein a dispersion is applied to a substrate which is solid at ambient temperature. Due to the use of a dispersion for the first time, a cleaning power with the features of a powdered washing detergent (zeolites, phyllosilicates) could be achieved. Primarily hydrophobic carrier substrates have been used because the laundry detergent dispersion also has hydrophilic characteristics due to higher amount of washing active substances as compared to the two-phase system. In this way, the activation of the washing active substances (phase emission diffusion) over a longer period could be observed.

The overview of the prior art above shows that, during the evolution of single dose laundry detergents, the physical application forms (polymer pouch, detergent board, detergent wipes), on the one hand, and the physical composition of the solutions (solutions, dispersions), on the other hand, have been modified.

In all products and methods, resp., mentioned above the control of the release of the washing active substances over time has not been taken into account, however. In view of a laundry detergent wipe this means that the diffusion of the washing active substances in the washing water cannot be varied significantly.

Accordingly, it is the object of the present invention to provide a heavy-duty laundry detergent wipe, wherein the diffusion of the washing active substances in the washing water can be controlled.

### SUMMARY OF THE INVENTION

It is an object of the present invention to provide a heavy-duty laundry detergent wipe, wherein the diffusion of the washing active substances (phase emission diffusion) can be controlled.

This object has been achieved by a method for manufacturing a heavy-duty laundry detergent wipe according to claim 1, characterized by the following steps: (a) hydrophobic coating of a hydrophilic substrate or hydrophilic coating of a hydrophobic substrate for obtaining a multilayered carrier substrate which is solid at ambient temperature, (b) applying a dispersion consisting of a liquid washing detergent and a water insoluble functional additive to the substrate.

This object has also been achieved by a heavy-duty laundry detergent wipe according to claim 4, comprising a substrate which is solid at ambient temperature and a dispersion applied to the substrate and consisting of a liquid washing detergent and a water insoluble functional additive, characterized in that the carrier substrate consists of a hydrophilic substrate provided with a hydrophobic coating or of a hydrophobic substrate provided with a hydrophilic coating.

Advantageous embodiments of the heavy-duty detergent wipe and its manufacturing method can be obtained from the dependent claims.

### DESCRIPTION OF THE PREFERRED EMBODIMENTS

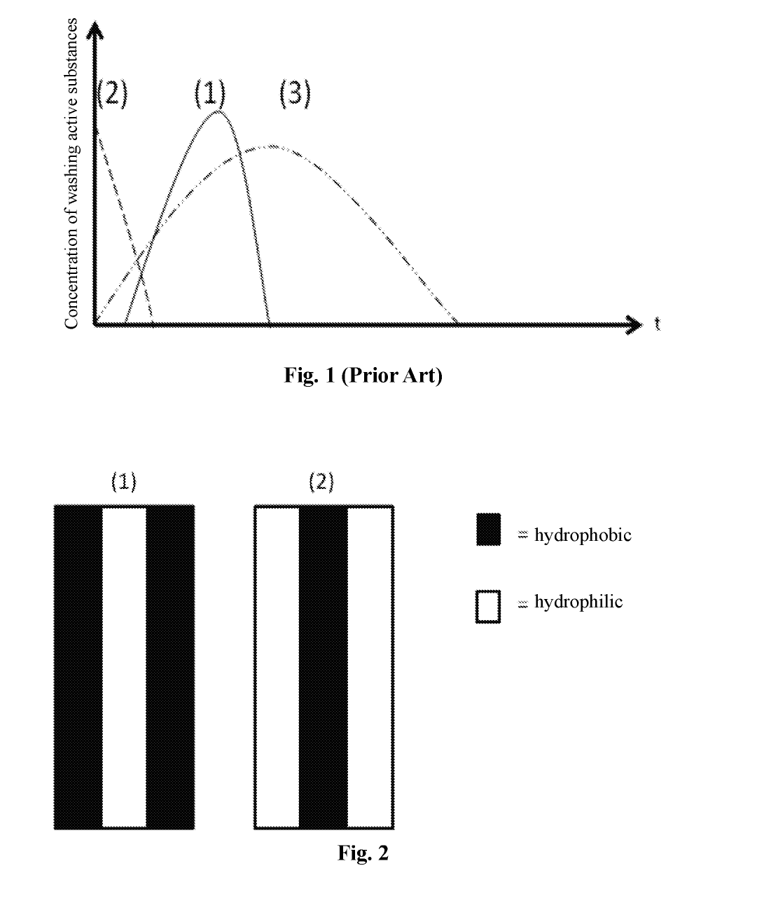

The—not controllable—release over time of the washing active substances of single dose laundry detergents according to the prior art is shown in FIG. 1: (1) shows the curve for liquid washing detergents filled in small polymer pouches, (2) shows the curve for laundry detergents mixed with fat alcohols and (3) shows the curve for the laundry detergent wipe according to DE 10 2010 060 126 A1. Surprisingly, the heavy-duty laundry detergent wipe according to the present invention with controlled phase emission diffusion of the washing active substances could be realized by hydrophobic coating of hydrophilic substrates and hydrophilic coating of hydrophobic substrates, resp., wherein the resulting substrate, which is solid at ambient temperature, is then provided with a laundry detergent dispersion as disclosed in DE 10 2013 014 015. The hydrophobic and hydrophilic coating, resp., can be carried out by impregnating, spraying or one- or two-sided coating on the surfaces of the substrate to be coated, namely on both sides of the substrate to be coated (in FIG. 2, (1) designates hydrophobic coating on both sides of a hydrophilic substrate and (2) hydrophilic coating on both sides of a hydrophobic substrate—hydrophobic=black/hydrophilic=white) or only on one side. The following hydrophilic substrates are particularly useful:
cellulose
viscose
other cellulose derivates

In the area of hydrophobic substrates the following are particularly useful:
polytethylene
polypropylene
polyester

For hydrophobic coating of hydrophilic substrates the following are particularly useful:
polymers
long-chain fat alcohols
waxes
oils
shea butter

Hydrophilic coating of hydrophobic substrates could be achieved in particularly by using:
polar waxes
polar oils
polyvalent fat alcohols
sulphonated compounds
sulphated compounds
alkoxylated compounds
amidated compounds
gluconated compounds
other compounds with functional hydrophilic head moiety

Due to the surface activation of the carrier substrate resulting from hydrophilic and hydrophobic, resp., coating dual activity zones could be realized during manufacturing of the laundry detergent wipe, wherein the zones are decisive for the addition of the laundry detergent dispersion. A primary addition of the laundry detergent dispersion in the outer zones of the carrier substrate can be achieved by using a hydrophilic substrate with hydrophobic coating. This results in an acceleration of the phase emission diffusion. This arrangement is particularly useful for short washing programs, for example. The inverse system (hydrophilic coating of hydrophobic substrates) shows a primary addition in the center of the carrier substrate such that the phase emission diffusion can be selectively decelerated. The intensity of the surface treatment (layer thickness of outer the treated surface) and/or the variation of the polarities of the surface activating additives (i.e., of the substances used for hydrophobic and hydrophilic, resp., coating) permits a selective control of the process of phase emission diffusion of a laundry detergent wipe for the first time.

The present invention can be used in all categories of laundry detergents. For example, the following laundry detergent solutions were used:

Heavy Duty Laundry Detergent Wipe (Universal):

anionic tensides
nonionic tensides
phosphonates/complex builders
C10-C18 fatty acid salts
optical brighteners
enzymes
builders (polycarboxylates, zeolites, phyllosilicates)
stabilizers (propylene glycol, glycerin, borax, inulin)
scents
preservatives
soil-release polymer
pH regulators

Color Laundry Detergent Wipe (Color):

anionic tensides
nonionic tensides
phosphonates/complex builders
C10-C18 fatty acid salts
colorants
color transfer protection
hydrotropes (sodium cumenesulfonate)
enzymes
builders (polycarboxylates, zeolites, phyllosilicates)
stabilizers (propylene glycol, glycerin, borax, inulin)
scents
preservatives
soil-release polymer
pH regulators

Black Laundry Detergent Wipe (Black):

anionic tensides
nonionic tensides
phosphonates/complex builders
C10-C18 fatty acid salts
colorants
color transfer protection
enzymes
builders (polycarboxylates, zeolites, phyllosilicates)
stabilizers (propylene glycol, glycerin, borax, inulin)
opacifiers
scents
preservatives
pH regulators

White Laundry Detergent Wipe (White):

anionic tensides
nonionic tensides
C10-C18 fatty acid salts
optical brighteners
soil-release polymer
color transfer protection
enzymes
builders (polycarboxylates, zeolites, phyllosilicates)
stabilizers (propylene glycol, glycerin, borax, inulin)
colorants
opacifiers
scents
preservatives
pH regulators

Fine Laundry Detergent Wipe:

anionic tensides
nonionic tensides
C10-C18 fatty acid salts
phosphonates/complex builders
color transfer protection
enzymes
builders (polycarboxylates, zeolites, phyllosilicates)
stabilizers (propylene glycol, glycerin, borax, inulin)
scents
defoamers
preservatives
pH regulators

Wool Laundry Detergent Wipe:

anionic tensides
nonionic tensides
amphoteric tensides
C10-C18 fatty acid salts
phosphonates/complex builders
color transfer protection
builders (polycarboxylates, zeolites, phyllosilicates)
scents
preservatives
opacifiers
conditioners
pH regulators

It was found that for wool and fine laundry detergent wipes the use of hydrophilic substrates with hydrophobic coating was suitable because shorter washing programs with lower temperatures are used. In the application of laundry detergent wipes for white, black, color and universal laundry the use of hydrophobic substrates with hydrophilic coating was found to be successful because the phase emission diffusion could be reduced in these cases.

The water insoluble functional additive of the heavy-duty laundry detergent dispersion can comprise a zeolite and/or a phyllosilicate. The liquid washing detergent of the dispersion can have a viscosity of larger than 500 mPas. The dispersion is statistically fixed to the carrier substrate. Furthermore, it can comprise all known components of a heavy-duty laundry detergent.

1. A method for the manufacturing of a heavy-duty laundry detergent wipe comprising the steps:
(a) obtaining a multilayered carrier substrate by
(i) hydrophobic coating of a hydrophilic substrate or,
(ii) hydrophilic coating of a hydrophobic substrate,
whereby said multilayered carrier substrate is solid at ambient temperature; and
(b) applying a dispersion comprising a liquid washing detergent and a water insoluble functional additive to the substrate.

2. The method of claim 1, wherein the said coating of the said substrate is carried out on one side only.

3. The method of claim 1, wherein the said coating of the said substrate is carried out on both sides.

4. A heavy-duty laundry detergent wipe, comprising a substrate which is solid at ambient temperature and a dispersion applied to the substrate said dispersion comprising a liquid washing detergent and a water insoluble functional additive, whereby the carrier substrate comprises a) a hydrophilic substrate provided with a hydrophobic coating or b) a hydrophobic substrate provided with a hydrophilic coating.

5. The heavy-duty laundry detergent wipe of claim 4, wherein the said coating of the said substrate is provided on one side only.

6. The heavy-duty laundry detergent wipe of claim 4, wherein the said coating of the said substrate is provided on both sides.

7. The heavy-duty laundry detergent wipe of claim 4, wherein the water insoluble functional additive comprises a zeolite and/or a phyllosilicate.

8. The heavy-duty laundry detergent wipe of claim 4, wherein the liquid washing detergent of the dispersion has a viscosity greater than 500 mPas.

9. The heavy-duty laundry detergent wipe of claim 4, wherein the dispersion is statistically fixed to the carrier substrate.

10. The heavy-duty laundry detergent wipe of claim 4, further comprising any known component of a heavy-duty laundry detergent.

11. The heavy-duty laundry detergent of claim 4, wherein the substrate to be coated is hydrophilic and is cellulose, viscose or other a cellulose derivates.

12. The heavy-duty laundry detergent wipe of claim 4, wherein the substrate to be coated is hydrophilic and is selected from cellulose, viscose, and a cellulose derivate and wherein the hydrophobic coating is carried out by using polymeres, long-chain fat alcohols, waxes, oils or shea butter.

13. The heavy-duty laundry detergent wipe of claim 4, wherein the substrate to be coated is hydrophobic and is polyethylene, polypropylene or polyester.

14. The heavy-duty laundry detergent wipe claim 4, wherein the substrate to be coated is hydrophobic and is polyethylene, polypropylene or polyester and wherein the hydrophilic coating is carried out by using polar waxes, polar oils, polyvalent fat alcohols, sulphonated compounds, sulphated compounds, alkoxylated compounds, amidated compounds, gluconated compounds, or other compounds having a functional hydrophilic head moiety.
